(19) United States
(12) Patent Application Publication
(10) Pub. No.: US 2026/0042467 A1
(43) Pub. Date: Feb. 12, 2026

(54) METHOD FOR PREDICTING A MOVEMENT OF A ROAD USER

(71) Applicant: MERCEDES-BENZ GROUP AG, Stuttgart (DE)

(72) Inventors: Julian SCHMIDT, Steißlingen (DE); Jan RUPPRECHT, Herrenberg (DE); Franz GRITSCHNEDER, Esslingen (DE); Julian JORDAN, Tübingen (DE)

(21) Appl. No.: 19/099,240

(22) PCT Filed: Jun. 27, 2023
(86) PCT No.: PCT/EP2023/067482

§ 371 Date: Jan. 28, 2025

(30) Foreign Application Priority Data
Jul. 29, 2022 (DE) 10 2022 002 769.0

(51) Int. Cl. B60W 60/00; B60W 30/095

(52) U.S. Cl. CPC B60W 60/0027; B60W 30/095

(57) ABSTRACT

Movement of a road user in a vehicle's surroundings is predicted using a vicinity of the road user represented in a raster map having a specified number of raster cells. The raster map is supplied to an artificial neural network as input information, and a trajectory of the road user is predicted from the input information by means of the neural network. A scale of the raster cells is dynamically scaled depending on a speed of the road user in order to scale a representation region of the raster map. A region of the vicinity of the road user that is larger when the road user is travelling at a high speed than when the road user is travelling at a low speed is represented by the raster map.

### BACKGROUND AND SUMMARY OF THE INVENTION

Exemplary embodiments of the invention relate to a method for predicting a movement of a road user in a vehicle's surroundings, as well as to a use of a movement of a road user, which movement is predicted in such a method.

A reliable prediction of the behavior of road users in a vehicle's surroundings is essential for an automated, in particular highly automated or autonomous driving operation of vehicles. Only when an automated vehicle system is able to reliably forecast the behavior of surrounding road users can future behavior of the automated vehicle be safely planned.

For such a prediction, different approaches are known from the prior art. These approaches comprise raster map-based approaches, among others, in which the vehicle's surroundings or parts of the vehicle's surroundings, for example a road geometry and a movement history of surrounding road users, also referred to as agents, are mapped in a raster map. This raster map shows the vehicle's surroundings from a bird's eye view. A road user to be predicted is located, for example, in the center of the raster map. Then, artificial neural networks, for example so-called convolutional neural networks, abbreviated to CNN, are used in order to process information of the raster map and to estimate therefrom a future trajectory of the road user to be predicted.

Such a method for predicting a movement of a road user is known from “Henggang Cui et al.: Multimodal Trajectory Predictions for Autonomous Driving using Deep Convolutional Networks; In: arXiv: 1809.10732v2 [cs.RO] 1 Mar. 2019”. For this purpose, several possible trajectories of road users in a vicinity of a vehicle or robot are forecast and the probabilities thereof are estimated. Furthermore, a vicinity context of each road user is coded into a raster image which is used by deep artificial neural networks, in order to automatically derive a trajectory for the road user. The raster map has a specified number of raster cells and three layers, corresponding to an RGB image. The layers contains both a static infrastructure, for example roads, as well as dynamic information, for example historical movement of a road user to be predicted and a surrounding road user.

Exemplary embodiments of the invention are directed to a novel method for predicting a movement of a road user, and a use of a movement of a road user, which movement is predicted in such a method.

In a method for predicting a movement of a road user in a vehicle's surroundings, a vicinity of the road user is represented in the form of a raster map having a specified number of raster cells, wherein the raster map is supplied to an artificial neural network as input information, and a trajectory of the road user is predicted from the input information by means of the neural network.

According to the invention, a scale of the raster cells is dynamically scaled depending on a speed of the road user in order to scale a representation region of the raster map. A region of the vicinity of the road user that is larger when the road user is travelling at a high speed than when the road user is travelling at a low speed is represented by means of the raster map.

By means of the present method and the dynamic scaling of the representation region, also referred to as a viewing region, it is avoided in a particularly advantageous manner with raster map-based approaches that, at a given resolution of a raster map, for example 256 pixels×256 pixels, it has to be defined before a training process of the artificial neural network which representation region this raster map covers in the real world, for example 50 meters×50 meters. Thus, a representation region covered by an individual raster cell of the raster map does not have to be prescribed.

This eliminates the need to define a defined and constant representation region and there is also no need to find a compromise, which would be the case with a fixed selection of the representation region of the raster map. This results from the fact that due to the dynamic specification of the representation region, for the road user to be predicted that is travelling at high speeds, for example a vehicle on a motorway, as large a representation region as possible is covered by means of the present method, meaning that road geometries and surrounding road users that are far away from the road user to be predicted are also taken into account for the prediction. Due to the dynamic specification of the representation region, the method also makes it possible to choose a smaller representation region for a road user to be predicted that is travelling at a low speed, for example of a vehicle in urban traffic, in order to be able to detect all nearby surrounding information in as much detail as possible.

In a particularly advantageous manner, existing prediction approaches for realizing the method can be expanded accordingly.

It is possible by means of the present method to eliminate the main weakness of raster map-based prediction approaches, specifically the fixed specification of the representation region of the raster map and the problems resulting therefrom. The method means that the representation region is no longer restricted, and no compromise has to be found for movements at low and high speeds. A further advantage is that high speeds of a road user do not automatically require higher resolutions of the raster map.

In a possible embodiment of the method, the representation region is determined according to

$$W = L = max ( 50 , 2 \frac{{v}^{2}}{( 2 a )} ) metres$$

with W=width of the representation region,
L=length of the representation region,
v=speed of the road user and
a=acceleration of the road user.

Therefore, there size of the representation region is scaled non-linearly to a braking distance, i.e.,

$$\frac{{v}^{2}}{( 2 a )}$$

of the road user to be predicted. Typical values for the acceleration of the road user are 3 m/s² to 5 m/s² for vehicles, for example. A lower limit of 50 meters is defined by the “max” operator.

In a further possible embodiment of the method, the input information is scaled depending on the scaled representation region. This means that the method can be realized by expanding on already existing prediction approaches.

In a further possible embodiment of the method, a scale factor of the scale of the raster cells is supplied to the neural network and/or to a network for further processing results determined by means of the network. This enables a conversion of the results determined from the possibly scaled input information and thus also enables the method to be realized by expanding on already existing prediction approaches.

In a further possible embodiment of the method, the representation region is scaled back to a specified value after the trajectory has been predicted, so that the region is in an initial state again, for example.

The use according to the invention of a movement of a road user, which movement is predicted in a method, in a vehicle's surroundings for operating an automated vehicle function enables a particularly precise and reliable operation of the automated vehicle function, for example an automated longitudinal and/or lateral control of the vehicle, due to the advantageous prediction of the road users in the vehicle's surroundings.

Exemplary embodiments of the invention are explained in more detail in the following using the drawings.

### BRIEF DESCRIPTION OF THE DRAWING FIGURES

Here:

FIG. 1 schematically shows a plan view of a traffic situation having several road users,

FIG. 2 schematically shows a plan view of a further traffic situation having several road users and a representation region of a raster map,

FIG. 3 schematically shows a plan view of a further traffic situation having several road users and a representation region of a raster map,

FIG. 4 schematically shows a block diagram of an apparatus for predicting a movement of a road user in a vehicle's surroundings according to the prior art, and

FIG. 5 schematically shows a block diagram of an apparatus for predicting a movement of a road user in a vehicle's surroundings.

Parts corresponding to each other are provided with the same reference signs in all the figures.

### DETAILED DESCRIPTION

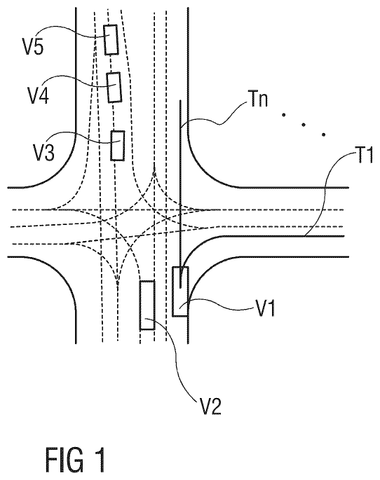

In FIG. 1 illustrates a plan view of a traffic situation having several road users V1 to V5, for example motor vehicles.

For an automated, in particular highly automated or autonomous, driving operation of a vehicle (not shown in more detail), it is necessary to predict future behavior and thus future movements of road users V1 to V5 present in a vicinity of the vehicle. Possible movements of the road user V1 are represented in this case by different possible trajectories T1 to Tn.

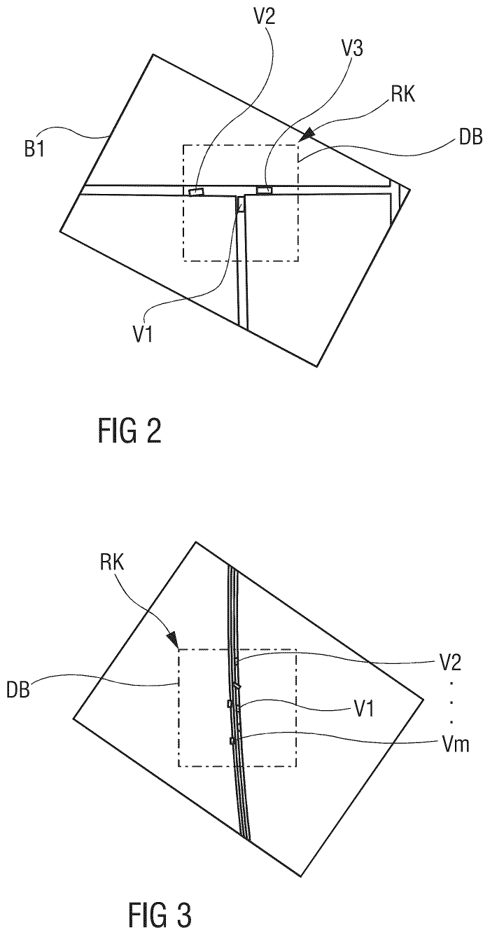

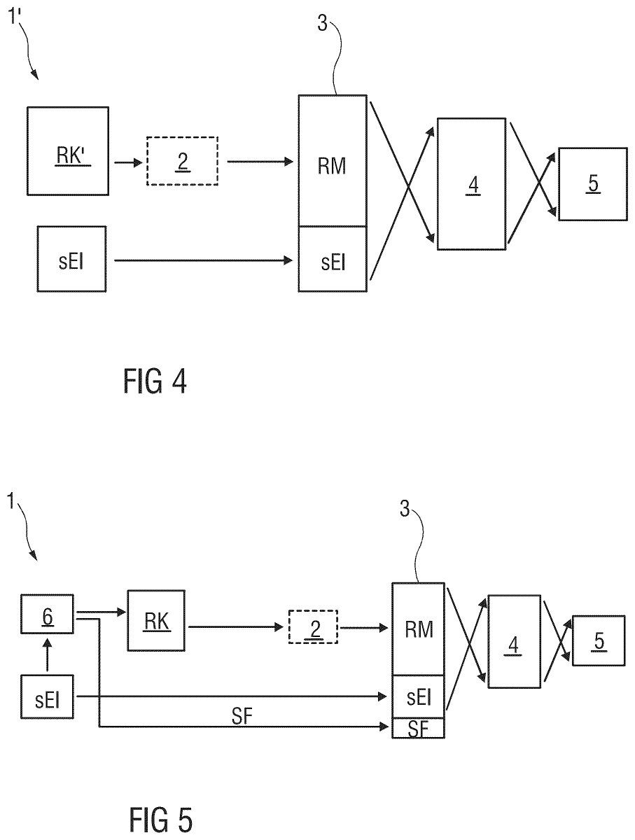

For example, raster map-based approaches are used for such a prediction. As a result, the vicinity or parts of the vicinity, for example a road geometry and a movement history of surrounding road users V1 to V5, also referred to as agents, is or are represented in a bird's eye view in a raster map RK shown in detail in FIGS. 2, 3 and 5. The road user V1 to V5 to be predicted, which is, for example, a vehicle, pedestrian, cyclist, or other road user V1 to V5, is located, for example, in the center of the raster map RK. Then, artificial neural networks 2, for example so-called convolutional neural networks abbreviated to CNN, that are shown in more detail in FIGS. 4 and 5 are used in order to process the information of the raster map RK and to estimate therefrom a future trajectory T1 to Tn of the road user V1 to V5 to be predicted.

FIG. 2 shows a plan view of a further traffic situation having several road users V1 to V3 and a representation region DB of a raster map RK. The road users V1 to V3 are in particular vehicles.

In order to eliminate compromises when selecting the representation region DB of the raster map RK in the described prediction of the movement of the corresponding road users V1 to V3 by means of a raster map-based approach, it is provided to dynamically scale the representation region DB. This eliminates the need to define a constant representation region DB, so that it is not necessary to find a compromise for different traffic scenarios, for example in a motorway environment or an urban environment.

This scaling takes place by dynamically scaling a scale of raster cells of the raster map RK depending on a speed of the road user V1 to V3 to be predicted.

A resolution of the raster map RK, for example 256 pixels×256 pixels, remains, in particular, fixed. However, it is determined dynamically during the operation which representation region DB is covered by the raster map RK. This dynamic determination is carried out depending on the instantaneous speed of the road user V1 to V3 to be predicted.

A larger representation region DB is covered for higher speeds of the corresponding road user V1 to V3 than for lower speeds. Thus, a representation region DB which is covered by an individual raster cell also changes.

A possible equation for determining dimensions of the representation region DB is

$$W = L = max ( 50 , 2 \frac{{v}^{2}}{( 2 a )} ) metres , \qquad ( 1 )$$

with W=width of the representation region DB,
L=length of the representation region DB,
v=speed of the road user V1 to V3 to be predicted and
a=acceleration of the road user V1 to V3 to be predicted.

In this case, a size of the representation region DB is scaled non-linearly to a braking distance, i.e.,

$$\frac{{v}^{2}}{( 2 a )}$$

of the road user V1 to V3 to be predicted. Typical values for the acceleration a of the road user V1 to V3 are 3 m/s² to 5 m/s² for vehicles, for example. A lower limit of 50 meters is defined by the “max” operator.

In the represented exemplary embodiment according to FIG. 2, the road users V1 to V3 are located in an urban environment, wherein the road user V1 is the vehicle to be predicted and the road users V2, V3 are vehicles located in the vicinity of the road user V1. An image B1 representing the traffic situation is rotated in such a way that a movement direction of the road user V1 to be predicted is directed upwards.

Due to the urban environment and the associated relatively low speeds of road users V1 to V3, in particular of the road user V1 to be predicted, the representation region DB of the raster map RK is relatively small.

In FIG. 3, a plan view of a further traffic situation having several road users V1 to Vm and a representation region DB of a raster map RK are represented, wherein the road users V1 to Vm are located on a motorway. In this case, the road user V1 is the vehicle to be predicted and the road users V2 to Vm are vehicles located in the vicinity of the road user V1. An image B2 representing the traffic situation is rotated in such a way that a movement direction of the road user V1 to be predicted is directed upwards.

In comparison to the exemplary embodiment shown in FIG. 2, the representation region DB of the raster map RK is chosen to be larger due to the higher speeds of the road users V1 to Vm on the motorway.

FIG. 4 shows a block diagram of an apparatus 1′ for predicting a movement of a road user V1 to Vm in a vehicle's surroundings according to a raster map-based approach according to the prior art.

The apparatus 1′ comprises an artificial neural network 2, for example a convolutional neural network, to which data from a defined, fixed-size specified raster map RK′ is supplied as input information.

The network 2 forms raster features RM from the input information and transmits these to a network 3, which links the raster features RM with state information sEI, which concerns for example a speed, a position, an angle, etc., and predicts trajectories T1 to Tn of road users V1 to Vm as results.

The results are stored in a storage device 4 and output by means of an output unit 5.

In FIG. 5, a block diagram of an apparatus 1 for predicting a movement of a road user V1 to Vm in a vehicle's surroundings is shown.

As an addition to the apparatus 1′ shown in FIG. 4, the apparatus 1 comprises a scaling module 6 for determining a scaling factor SF for scaling the raster map RK as described in FIGS. 2 and 3.

Here, firstly, a speed of the road user V1 to Vm to be predicted is determined from the state information sEI.

Subsequently, the scaling factor SF for scaling the representation region DB of the raster map RK is determined by means of the scaling module 6, and subsequently the raster map RK is scaled accordingly. The data of the thus scaled raster map RK is then supplied to the network 3.

Furthermore, the state information sEI is scaled depending on the determined representation region DB, and the scaling factor SF is supplied to the network 3 as additional input information. Subsequently, the corresponding trajectory T1 to Tn is predicted and after this prediction, the representation region DB is scaled back to a specified value.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-6. (canceled)

7. A method for predicting a movement of a road user in a vehicle's surroundings, the method comprising:
representing a vicinity of the road user in a raster map having a specified number of raster cells, wherein a scale of the raster cells is dynamically scaled depending on a speed of the road user to scale a representation region of the raster map so that a region of the vicinity of the road user is larger when the road user is travelling at a high speed than when the road user is travelling at a low speed;
supplying the raster map to an artificial neural network as input information; and
predicting, by the artificial neural network, a trajectory of the road user from the input information.

8. The method of claim 7, wherein the representation region is determined according to
$$W = L = max ( 50 , 2 \frac{{v}^{2}}{( 2 a )} ) metres$$
with W=width of the representation region,
L=length of the representation region,
v=speed of the road user, and
a=acceleration of the road user.

9. The method of claim 7, wherein the input information is scaled depending on the scaled representation region.

10. The method of claim 7, wherein a scale factor of the scale of the raster cells is supplied to the neural network or to a network for further processing results determined by means of the network.

11. The method of claim 7, wherein the representation region is scaled back to a specified value after a trajectory of the road user has been predicted.

12. A method for using a predicted movement of a road user in a vehicle's surroundings, the method comprising:
representing a vicinity of the road user in a raster map having a specified number of raster cells, wherein a scale of the raster cells is dynamically scaled depending on a speed of the road user to scale a representation region of the raster map so that a region of the vicinity of the road user is larger when the road user is travelling at a high speed than when the road user is travelling at a low speed;
supplying the raster map to an artificial neural network as input information;
predicting, by the artificial neural network, a trajectory of the road user from the input information; and
using the predicted trajectory to control movement of the vehicle during automated vehicle operation.
